(19) United States
(12) Patent Application Publication
(10) Pub. No.: US 2009/0281266 A1
(43) Pub. Date: Nov. 12, 2009

(54) Star silicone resins

(76) Inventors: Kevin Anthony O'Lenick, Dacula, GA (US); Anthony J. O'Lenick, JR., Dacula, GA (US)

Correspondence Address: ANTHONY J O'LENICK JR, 2170 LUKE EDWARDS ROAD, DACULA, GA, 30019, US

(21) Appl. No.: 12/156,404

(22) Filed: Jun. 2, 2008

Related U.S. Application Data
(60) Provisional application No. 61/127,446, filed on May 12, 2008.

(51) Int. Cl. C08G 77/20

(52) U.S. Cl. 528/32

(57) ABSTRACT

The present invention relates to a series of crosslinked silicone polymers that by virtue of the nature of the crosslinker, have unique film forming and skin feel properties. They are made by the reaction of vinyl silicones and star silanic hydrogen compounds.

### RELATED APPLICATIONS

This application claims priority to and benefit of U.S. Provisional Application No. 61/127,446 filed May 14, 2008, the disclosure of which is incorporated herein for all purposes.

### FIELD OF THE INVENTION

The present invention relates to a series of crosslinked silicone polymers that by virtue of the nature of the crosslinker have unique structure and properties. These include improved tolerance for oily materials and water soluble materials. These polymers find use in personal care applications like pigmented products. In the personal care arena, solid products that do not experience syneresis are important. Syneresis is a condition that exists in a solid product that causes a liquid that is incompatible to ooze out, which is cosmetically unacceptable.

### BACKGROUND OF THE INVENTION

1. Field of the Invention

The present invention is directed to a multifunctional organo-silicone compound and the use of that compound in personal care and other applications. These compounds by virtue of their unique structure provide outstanding films and provide outstanding skin feel.

2. Background of the Invention

Organofunctional silicone compounds are one of two types, internal and terminal depending upon the location of the silicone group.

The so-called terminal group has the organic functional groups at the alpha and omega terminus of the molecule. Typical of this class of compounds is the class of compounds currently called bis-dimethicone conforming to the following structure:

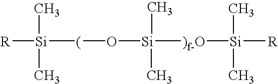

In the case where R is —(CH₂)₁₅—CH₃ the compound is bis cetyl dimethicone,

The other type of compound is one in which the organo-functionality is located on non-terminal ends of the molecule. This type of compound is called a “comb” compound since the organo-functionality lies in the molecule much like the teeth of a comb. These compounds are shown in the following structure:

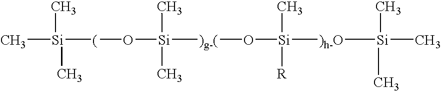

In the case where R is —(CH₂)₁₅—CH₃ the compound is simply cetyl dimethicone,

There are limitations on the properties of the silicone compounds of these classes and the products are often used in different applications. The functionality of these materials is determined by the way in which they orientate in solvent. Specifically, in what conformation the lowest energy is achieved. Since oil and silicone are not soluble in each other the internal oil soluble groups rotate around the Si—O—Si bond and associate with each other in essentially spherical globules.

Star silicone compounds have substitution at terminal and internal positions,

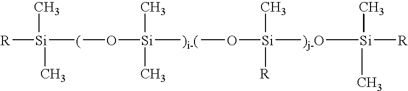

They are such like a tennis ball wherein the internal portion of the ball is silicone and the fuzzy surface is organic.

The term silicone resin has been applied both to and misapplied to a variety of materials over time. Silicone resins as used herein refer to a series of products which include at least two silicone backbones that are joined by a “crosslinking group”. The number of crosslinking groups that are present as a percentage of the total molecular weight will determine the properties of the resulting polymer.

If there are no crosslinking groups; the polymer can freely rotate and consequently is an oily liquid. If a few crosslinking groups are introduced, the ability to rotate is slightly restricted and the oily material becomes “rubbery”. The rubbery material should be referred to as an elastomer. The properties are morel like a rubber band than plastic. As the percentage of crosslinking increases still the molecule becomes rigid. This class of compounds are resins. If you hit the film with a hammer and it shatters it is a resin, if it bounces it is an elastomer and if it squirts out is a silicone fluid.

The difficulty in determining if a product is a fluid an elastomer or resin occurs for products that lie between the classifications. Specifically, when does an elastomer become a resin? While this exact point is of academic interest it does not have nay practical significance to the present invention.

There are a number of classes of resin compounds differing in the nature of the crosslinker. One class is the so called “Q resins”.

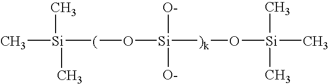

The oxygen that needs another bond connects to another polymer as shown:

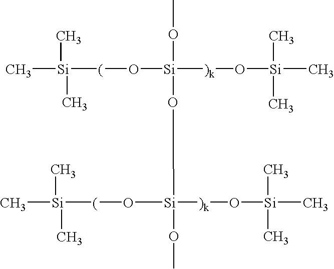

The crosslinking group is —O—. This type of resin is disclosed in U.S. Pat. No. 6,139,823, incorporated herein by reference. This type of material has a group, the so called “Q” group in which a Si has four oxygen atoms attached. In the above case it is the group that is within the “k” subscript. This type of resin is very powdery and is rarely used without a plasticizer. This class of compounds can also dry the skin.

The next class of resin contains alkyl connecting groups.

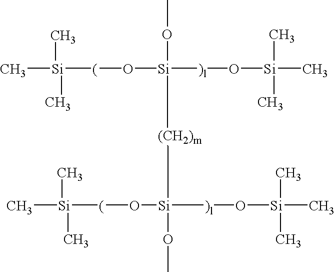

In the case where m=1 acetylene is used as a crosslinking reactant. It is reacted with a silanic hydrogen polymer. As n is increased the reactant is an alpha omega divinyl compound.

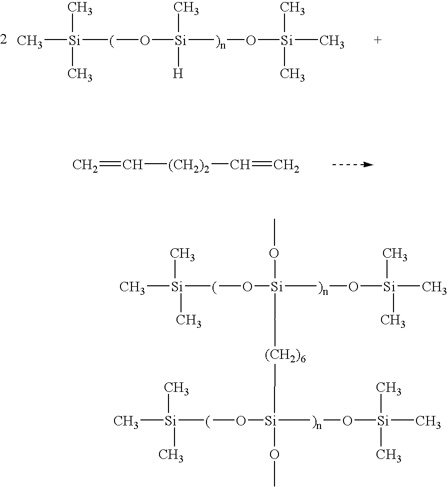

The reaction is called hydrosilylation and provides the linking groups between the molecules. The reaction is generally run in solvent like cyclomethicone (D4 or D5 or hexamethyl disiloxane) or in volatile organic like isododecane. A catalyst generally a platinum one is used to effect the reaction. Chloroplatinic acid or Karnsteadt catalyst are preferred. The resulting material is a viscous liquid that when the solvent evaporates provides a film.

The present invention makes use of novel crosslinking reagents, namely star hydrosilicones that provide groups heavily crosslinked in complex three dimensional structures forming elastomers and resins with optical clarity and outstanding skin feel. None of these advantageous present in the compounds are known heretofore.

### THE INVENTION

### Object of the Invention

It is the object of the present invention to provide a series of silicone polymers that have multi-dimensional crosslinking groups. The groups are all reactive with vinyl silicone to provide a crosslinked product. The complex structure of the star silanic hydrogen compound results in unique gelled structures.

Another object of the present invention is to provide a series of products suitable for formulation into personal care products providing improved skin feel (i.e. not drying like Q resins) and having improved solubility over alkyl linked polymers.

Other objects of the invention will become clear as one reads the specification attached hereto.

All % given herein are % by weight, all temperatures are ° C., and all patents and publications referred to herein are incorporated herein by reference in their entirety as appropriate.

### SUMMARY OF THE INVENTION

The present invention relates to a series of silicone resins that (a) provide improved skin feel and film formation depending upon the specific crosslinker chosen; and (b) provide products with a low degree of syneresis when placed in lipstick systems.

The compounds of the present invention are made by reacting specific alpha omega multi-vinyl compounds with silicone compounds that contain star silanic hydrogen (Si—H) groups. The reaction is conducted in a suitable solvent selected from the group consisting of cyclomethicone (D-4 and D-5 and mixtures thereof) and isoalkanes (iso-dodecane).

Star silicone compounds of interest to the present invention have silanic hydrogen substitution at terminal and internal positions,

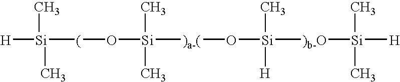

a is an integer ranging from 0 to 2000;
b is an integer ranging from 1 to 20.

They react with vinyl containing compounds to form resins with vinyl compounds selected from the group consisting of:

(a) terminal vinyl compounds conforming to the following structure:

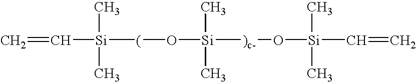

c is an integer ranging from 10 to 2000;
and
(b) internal vinyl compounds conforming to the following structure

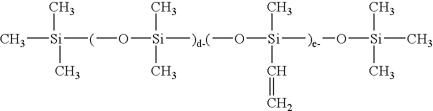

d is an integer ranging from 0 to 2000;
e is an integer ranging from 2 to 20.

### DETAILED DESCRIPTION OF THE INVENTION

Resins of the present invention are a class of silicone compounds, which are prepared by the reaction of a poly-vinyl compound, reacted with a “star” silanic hydrogen-containing compound.

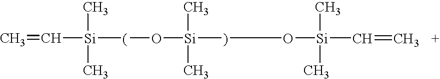

The first addition is to the Si—H

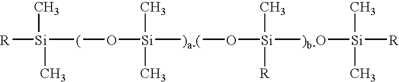

### R is

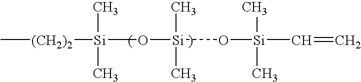

The remaining Si—H groups react with the vinyl group to crosslink and form a resin.

In the case of the internal vinyl the R group formed initially is

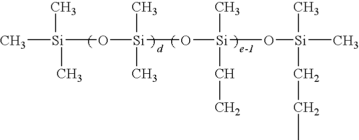

Clearly as the value of “e” increases the crosslinking increases and the product becomes more resinous.

The reactions are typically carried out in a solvent, either volatile silicone (cyclomethicone (D4 or D5 or mixtures thereof) or hydrocarbon solvent like isododecane. A suitable hydrosilylation catalyst like chloroplatinic acid or Karnstedt catalyst are used.

The value of “b” and “e” determines the degree of crosslinking and consequently if the product is resinous or elastomeric. Elastomeric materials are compounds that are crosslinked to a lesser extent than resins. They are “rubbery” producing films that are rubber band like. Resins in contrast are not rubbery, but ate hard and because of their higher crosslink density form powders when struck by a hammer.

The present invention is directed to a silicone polymer made by the hydrosilylation reaction of

(a) a star silicone compound conforming to the following structure:

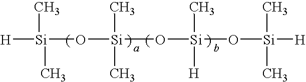

wherein;

a is an integer ranging from 0 to 2000;

b is an integer ranging from 1 to 20.

and

(b) a vinyl silicone compound selected from the group consisting of:

(i) terminal vinyl compounds conforming to the following structure:

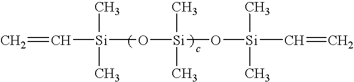

c is an integer ranging from 10 to 2000;

and

(ii) internal vinyl silicone compound conforming to the following structure

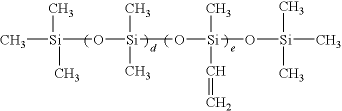

d is an integer ranging from 0 to 2000;
e is an integer ranging from 2 to 20.

### PREFERRED EMBODIMENTS

In a preferred embodiment said vinyl silicone is a terminal silicone compound conforming to the following structure:

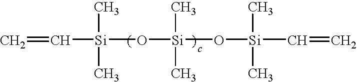

c is an integer ranging from 10 to 2000.

In a preferred embodiment c is an integer ranging from 10 to 200.

In a preferred embodiment c is an integer ranging from 10 to 50.

In a preferred embodiment c is an integer ranging from 10 to 20.

In a preferred embodiment a is an integer ranging from 1 to 200.

In a preferred embodiment a is an integer ranging from 2 to 20.

In a preferred embodiment a is an integer ranging from 2 to 10.

In a preferred embodiment b is an integer ranging from 2 to 10.

In a preferred embodiment said vinyl silicone is an internal silicone compound conforming to the following structure:

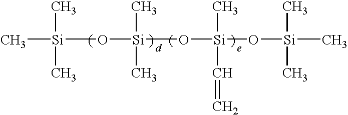

d is an integer ranging from 0 to 2000;
e is an integer ranging from 2 to 20.

In a preferred embodiment d is an integer ranging from 1 to 200.

In a preferred embodiment d is an integer ranging from 10 to 50.

In a preferred embodiment d is an integer ranging from 10 to 20.

In a preferred embodiment a is an integer ranging from 1 to 200.

In a preferred embodiment a is an integer ranging from 2 to 20.

In a preferred embodiment a is an integer ranging from 2 to 10.

In a preferred embodiment b is an integer ranging from 2 to 10.

In a preferred embodiment e is an integer ranging from 2 to 10.

In a preferred embodiment e is an integer ranging from 2 to 5.

In a preferred embodiment e is an integer ranging from 3 to 5.

### EXAMPLES

### Raw Materials Vinyl Silicones

### Example 1-5

Terminal vinyl compounds are available as commercial materials from Siltech LLC Dacula, Ga. and conform to the following structure:

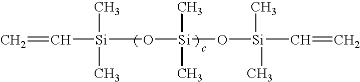

c is an integer ranging from 10 to 2000;

| Example | c |
|---|---|
| 1 | 10 |
| 2 | 20 |
| 3 | 30 |
| 4 | 150 |
| 5 | 2000 |

### Example 6-10

Internal vinyl compounds are available as commercial materials from Siltech LLC Dacula, Ga. and conform to the following structure

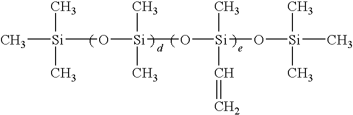

d is an integer ranging from 0 to 2000;
e is an integer ranging from 2 to 20.

| Example | d | e |
|---|---|---|
| 6 | 0 | 2 |
| 7 | 25 | 5 |
| 8 | 100 | 10 |
| 9 | 300 | 8 |
| 10 | 2000 | 20 |

### Star Silicones Examples 11-15

Star silicones are available from Siltech LLC Dacula, Ga. and conform to the following structure:

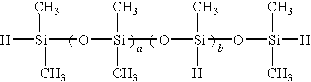

a is an integer ranging from 0 to 2000;
b is an integer ranging from 1 to 20.

| Example | a | b |
|---|---|---|
| 11 | 0 | 1 |
| 12 | 10 | 5 |
| 13 | 100 | 20 |
| 14 | 50 | 3 |
| 15 | 2000 | 15 |

Hydrosilylation Compounds of the Present invention

### Hydrosilylation Solvents

### Examples 16-18

The hydrosilylation reactions are advantageously run in a volatile solvent, which can later be distilled off is desired. It is also a practice to sell the products in solvent.

| Example | Description |
|---|---|
| 16 | isododecane |
| 17 | cyclomethicone |
| 18 | isodecane |

Hydrosilylation

Hydrosilylation is a process that reacts terminal vinyl compounds with silanic hydrogen to obtain a Si—C bond. References to this reaction, incorporated herein by reference, include:

U.S. Pat. Nos. 3,715,334 and 3,775,452 to Karstedt, shows the use of Pt(O) complex with vinylsilicon siloxane ligands as an active hydrosilylation catalyst.

Additional platinum complexes, such as complexes with platinum halides are shown by, U.S. Pat. No. 3,159,601 Ashby and, U.S. Pat. No. 3,220,972, to Lamoreaux.

Another hydrosilylation catalyst is shown by Fish, U.S. Pat. No. 3,576,027. Fish prepares a platinum(IV) catalyst by reacting crystalline platinum(IV) chloroplatinic acid and organic silane or siloxane to form a stable reactive platinum hydrosilylation catalyst.

General Procedure

To the specified number of grams of the specified solvent is added the specified number of grams of the specified Star silanic hydrogen compound (Example 11-15). The mass is mixed well. To that mixture is added the specified number of grams of the specified vinyl crosslinker compound (Example 1-10). The reaction mass is mixed well until homogeneous. To that mixture is added 0.1% Karstedt catalyst, which is commercially available from Geleste. The agitation is stopped and the reaction begins. The reaction mass will thicken over 4 hours. Once the maximum viscosity is reached the reaction is considered complete. The solvent may be distilled off or the product may be sold as prepared without additional purification.

### Examples 19-28

| | | | Star | | | |
|---|---|---|---|---|---|---|
| Exam- | Vinyl compound | | Silanic Hydrogen | | Solvent | |
| ple | Example | Grams | Example | Grams | Example | Grams |
| 19 | 1 | 464 | 11 | 69 | 16 | 2500 |
| 20 | 2 | 834 | 12 | 177 | 17 | 4500 |
| 21 | 3 | 1147 | 13 | 410 | 18 | 5000 |
| 22 | 4 | 564 | 14 | 81 | 16 | 3000 |
| 23 | 5 | 741 | 15 | 88 | 17 | 4000 |
| 24 | 6 | 168 | 11 | 69 | 17 | 1000 |
| 25 | 7 | 489 | 12 | 177 | 18 | 3500 |
| 26 | 8 | 842 | 13 | 410 | 16 | 6000 |
| 27 | 9 | 288 | 14 | 81 | 17 | 1500 |
| 28 | 10 | 83 | 15 | 878 | 18 | 5000 |

As the reaction is completed the viscosity increases and a resin is formed. The resins vary from soft silky powder lie materials to stiff rubbery film formers. The higher the higher the a+c+d value is over the b+e value the more elastomeric (soft) the product. The a+c+d value relate to the non-crosslinked sections and the b+e values relate to the crosslink sections.

These materials are resins useful in cosmetic products including but not limited to lipsticks, skin care products and color cosmetics.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth hereinabove but rather that the claims be construed as encompassing all the features of patentable novelty which reside in the present invention, including an features which would be treated as equivalents thereof by those skilled in the art to which the invention pertains.

1. A silicone polymer made by the hydrosilylation reaction of
(a) a star silicone compound conforming to the folowing structure: 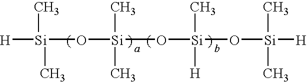
wherein;
a is an integer ranging from 0 to 2000;
b is an integer ranging from 1 to 20.
and
(b) a vinyl silicone compound selected from the group consisting of:
(i) terminal vinyl compounds conforming to the following structure: 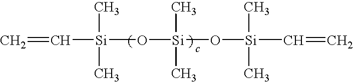
c an integer ranging from 10 to 2000;
and
(ii) internal vinyl silicone compound conforming to the following structure 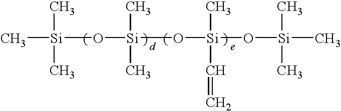
d is an integer ranging from 0 to 2000;
e is an integer ranging from 2 to 20.

2. A silicone polymer of claim 1 wherein said vinyl silicone is a terminal silicone compound conforming to the following structure: 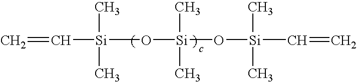
c is an integer ranging from 10 to 2000.

3. A silicone compound of claim 2 wherein c is an integer ranging from 10 to 200.

4. A silicone compound of claim 2 wherein c is an integer ranging from 10 to 50.

5. A silicone compound of claim 2 wherein c is an integer ranging from 10 to 20.

6. A silicone compound of claim 2 wherein a is an integer ranging from 1 to 200.

7. A silicone compound of claim 2 wherein a is an integer ranging from 2 to 20.

8. A silicone compound of claim 2 wherein a is an integer ranging from 2 to 10.

9. A silicone compound of claim 2 wherein b is an integer ranging from 2 to 10.

10. A silicone polymer of claim 1 wherein said vinyl silicone is an internal silicone compound conforming to the following structure: 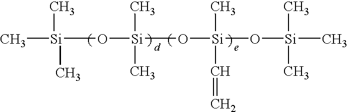
d is an integer ranging from 0 to 2000;
e is an integer ranging from 2 to 20.

11. A silicone compound of claim 10 wherein d is an integer ranging from 1 to 200.

12. A silicone compound of claim 10 wherein d is an integer ranging from 10 to 50.

13. A silicone compound of claim 10 wherein d is an integer ranging from 10 to 20.

14. A silicone compound of claim 10 wherein a is an integer ranging from 1 to 200.

15. A silicone compound of claim 10 wherein a is an integer ranging from 2 to 20.

16. A silicone compound of claim 10 wherein a is an integer ranging from 2 to 10.

17. A silicone compound of claim 10 wherein b is an integer ranging from 2 to 10.

18. A silicone compound of claim 10 wherein e is an integer ranging from 2 to 10.

19. A silicone compound of claim 10 wherein e is an integer ranging from 2 to 5.

20. A silicone compound of claim 10 wherein e is an integer ranging from 3 to 5.
